(19) United States
(12) Patent Application Publication
(10) Pub. No.: US 2026/0365500 A1
(43) Pub. Date: Nov. 19, 2026

(54) CONTAINER UNLOADING APPARATUS

(71) Applicant: Southworth International Group, Inc., Falmouth, ME (US)

(72) Inventors: Jonathan Graeme Robertson, Biddeford, ME (US); Emmanuel Marsh-Sachs, Sidney, ME (US); Scott Stoddard, Gorham, ME (US); Richard Burt, Gorham, ME (US)

(21) Appl. No.: 19/677,033

(22) Filed: May 14, 2026

Related U.S. Application Data
(60) Provisional application No. 63/805,624, filed on May 14, 2025.

(51) Int. Cl. B66F 9/04; B66F 17/00

(52) U.S. Cl. CPC B66F 9/04; B66F 17/00

(57) ABSTRACT

An apparatus for emptying contents from a container includes a mast with a power unit, a drive interface coupled to the mast, and a frame pivotally coupled to the drive interface. The frame includes a platform for supporting the container. An outrigger extends from the mast adjacent a side of the frame, and at least one constraint arm is pivotally coupled between the outrigger and the frame. The power unit drives the drive interface vertically to move the frame from a loading position to an unloading position. As the frame moves from the loading position to the unloading position, the frame moves upwardly and rotates relative to the drive interface and the constraint arm, while the constraint arm rotates relative to the outrigger. This combined vertical and rotational movement maintains the apparatus within a compact envelope space during operation.

### CROSS-REFERENCE TO RELATED APPLICATIONS

The present application claims the benefit of the filing date of U.S. Provisional Application Ser. No. 63/805,624, filed May 14, 2025, the entire teachings of which are hereby incorporated herein by reference.

### TECHNICAL FIELD

The technical field relates to management of containers and, more specifically, to a container unloading apparatus.

### BACKGROUND INFORMATION

Containers are often used in industrial applications to manage large amounts of inventory. These containers are often filled with like pieces such as, for example, manufactured parts, raw materials, mail, goods, etc. Because these containers are heavy and unwieldy, loaders and unloaders are often specialized to facilitate loading and unloading of the containers.

### BRIEF DESCRIPTION OF THE DRAWINGS

Objects, features, and advantages disclosed herein will be apparent from the following description of particular embodiments, as illustrated in the accompanying drawings in which like reference characters/descriptions refer to the same parts throughout the different views. The drawings are not necessarily to scale, emphasis instead being placed upon illustrating the principles disclosed herein. For purposes of clarity, not every component may be labeled in every drawing.

FIG. 1 is a right, front perspective view of one example embodiment of a container unloading apparatus consistent with the present disclosure wherein a frame of the apparatus is in a loading position.

FIG. 2 is a left, front perspective view of the container unloading apparatus shown in FIG. 1.

FIG. 3 is a front view of the container unloading apparatus shown in FIG. 1.

FIG. 4 is a left side view of the container unloading apparatus shown in FIG. 1.

FIG. 5 is a left, front perspective view of the mast and outrigger of the container unloading apparatus shown in FIG. 1.

FIG. 6 is a right, front perspective view of the drive interface of the container unloading apparatus shown in FIG. 1.

FIG. 7 is a front view of the drive interface shown in FIG. 1.

FIG. 8 is a right, front perspective view of the frame of the container unloading apparatus shown in FIG. 1.

FIG. 9A is a left side view of the container unloading apparatus shown in FIG. 1 with a container disposed on the frame and the frame in the loading position.

FIG. 9B is a right, front perspective view of the container unloading apparatus shown in FIG. 1 with the frame having the container disposed thereon and transitioning from the loading position to an unloading position.

FIG. 9C is a right, front perspective view of the container unloading apparatus shown in FIG. 1 with the frame having the container disposed thereon and transitioning from the loading position to an unloading position.

FIG. 9D is a left, front perspective view of the container unloading apparatus shown in FIG. 1 with the frame having the container thereon and in the unloading position.

### DETAILED DESCRIPTION

The present disclosure is not limited in its application to the details of construction and the arrangement of components set forth in the following description or illustrated in the drawings. The examples described herein may be capable of other embodiments and of being practiced or being carried out in various ways. Also, the phraseology and terminology used herein is for the purpose of description and should not be regarded as limiting as such may be understood by one of skill in the art. Throughout the present description, like reference characters may indicate like structure throughout the several views, and such structure need not be separately discussed. Furthermore, any particular feature(s) of a particular exemplary embodiment may be equally applied to any other exemplary embodiment(s) of this specification as suitable. In other words, features between the various exemplary embodiments described herein are interchangeable, and not exclusive.

Embodiments of a container unloading apparatus consistent with the present disclosure may be described herein in connection with a rolling container, e.g., a cart, having wheels thereon. The cart may be rolled onto the container unloading apparatus and supported thereon for unloading. It is to be understood, however, that a container unloading apparatus consistent with the present disclosure is not limited to use with rolling containers. In some embodiments, the non-rolling container may be placed on the container apparatus for unloading, e.g., by hand, by use of a powered or manual hand truck, by a forklift, by a robot, etc. The embodiments shown and described herein are provided by way of illustration, not of limitation.

An apparatus for emptying the contents of a container consistent with some embodiments of the present disclosure may include: a drive interface; a frame pivotally coupled to the drive interface and including a platform for supporting a container; a mast coupled to the drive interface and including a power unit for driving the drive interface vertically to move the frame from a loading position for loading the container on the platform to an unloading position for emptying contents from the container; an outrigger coupled to the mast and extending from the mast and adjacent a side of the frame; and at least one constraint arm pivotally coupled to the outrigger and pivotally coupled to the frame. As the frame moves from the loading position to the unloading position the frame moves upwardly and rotates relative to the drive interface and the at least one constraint arm, and the at least one constraint arm rotates relative to the outrigger. Due to the vertical and rotational movement of the frame as the frame moves from the loading position to the unloading position the frame remains in a compact envelope space. This allows use of apparatus consistent with the present disclosure at locations where space is limited and/or in a manner that efficiently uses existing space.

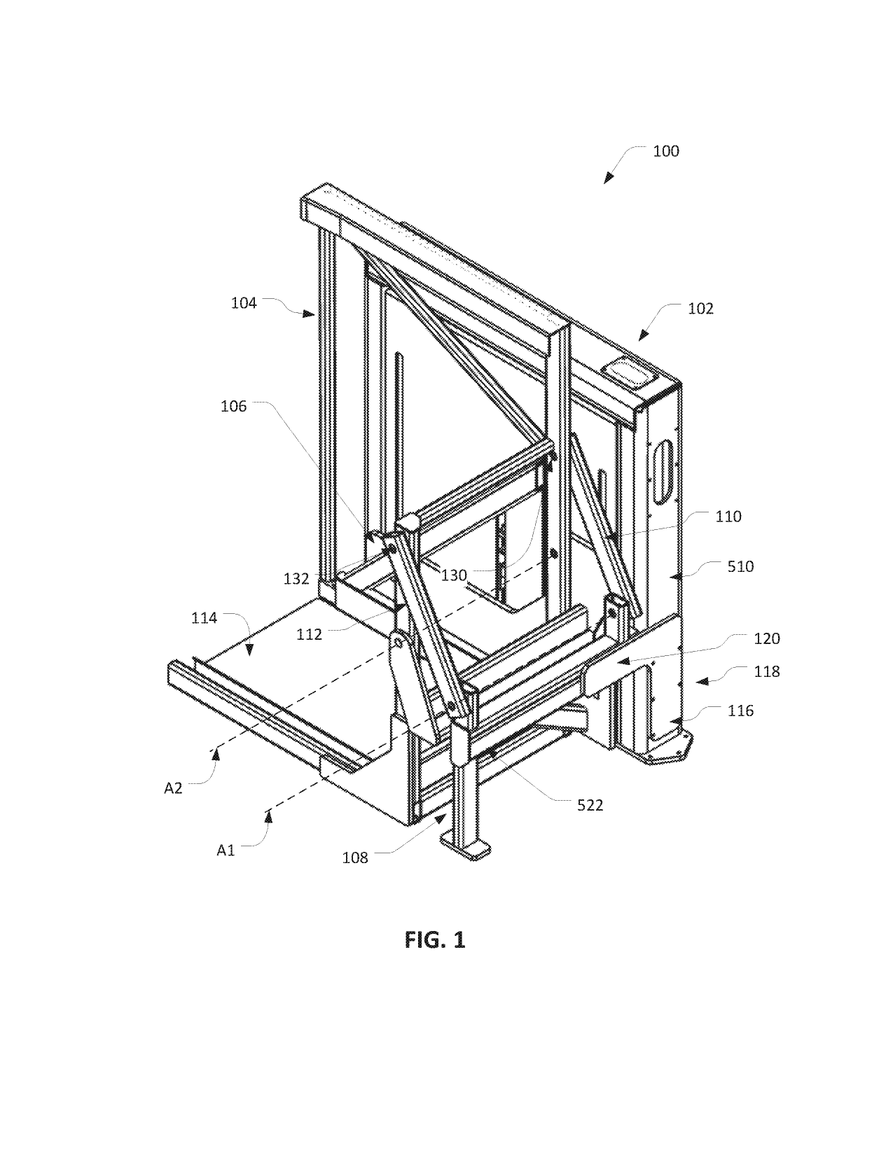

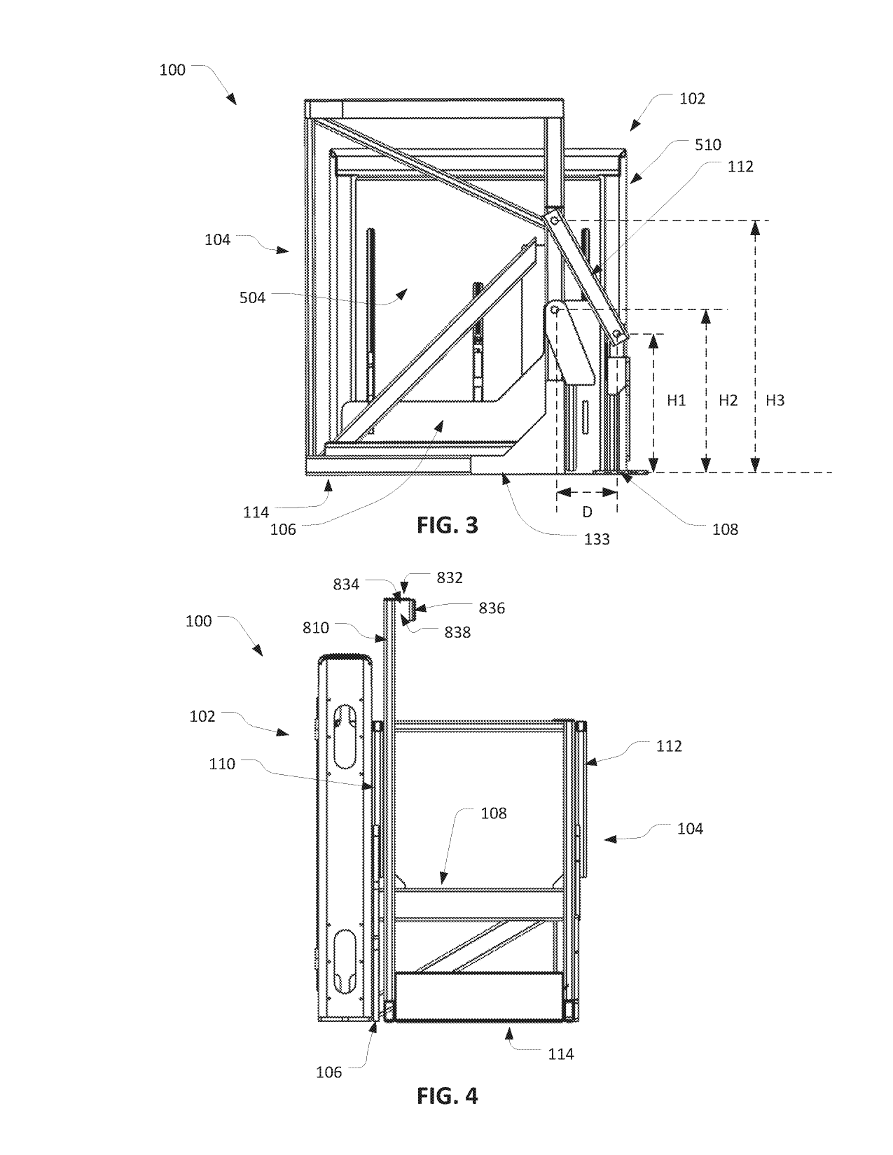

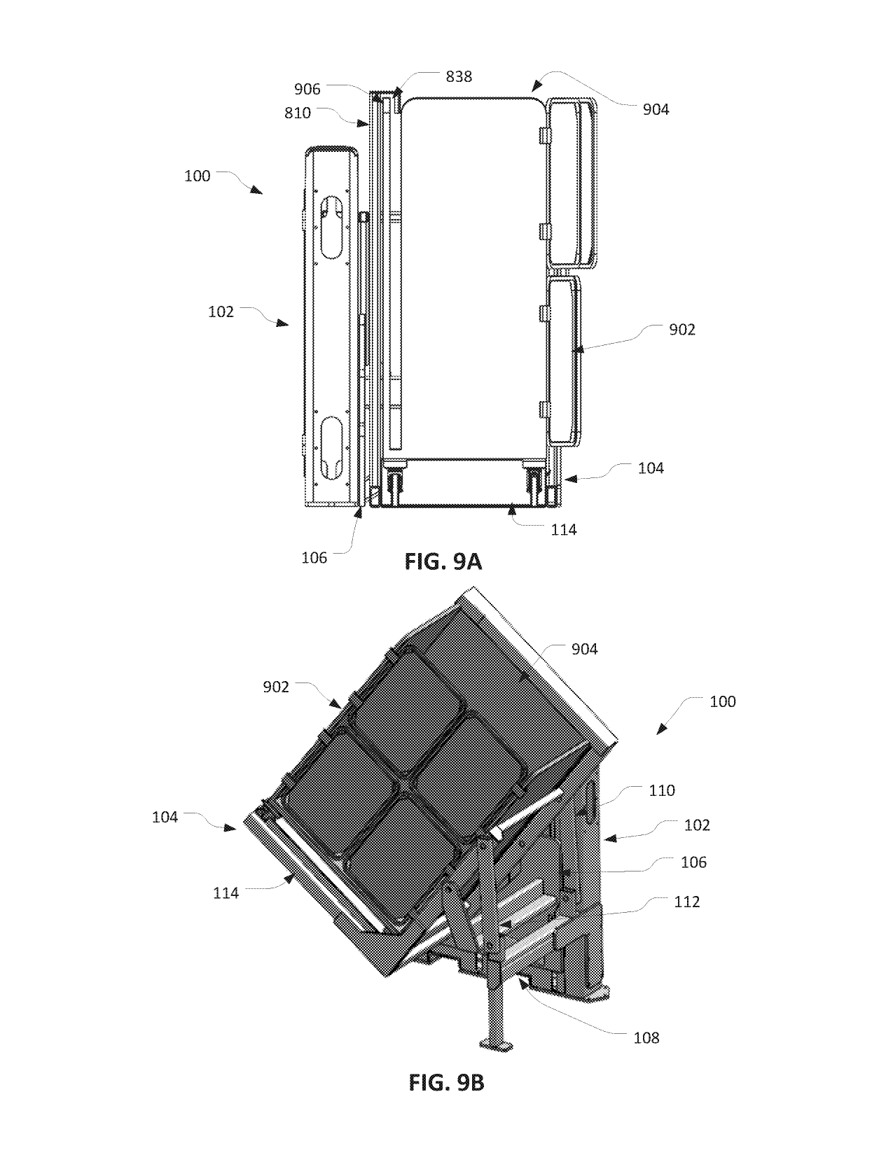

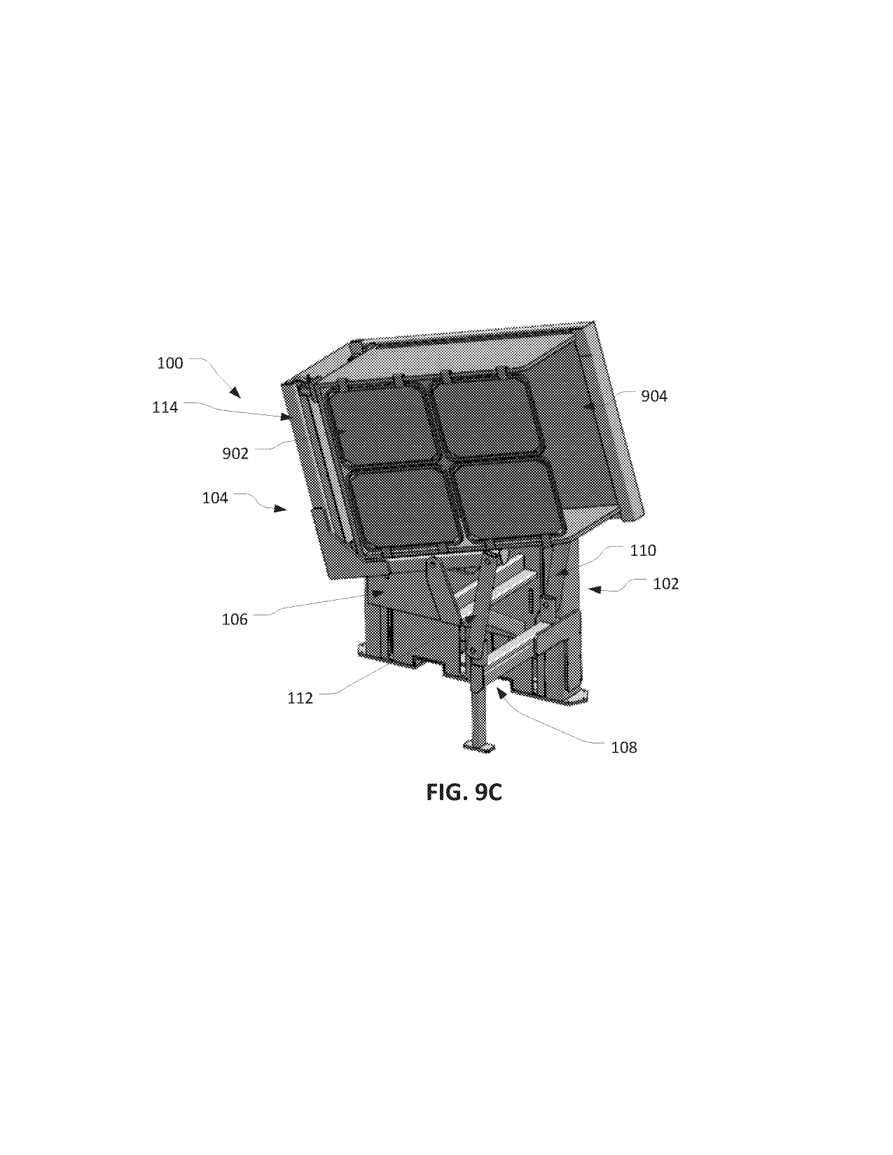

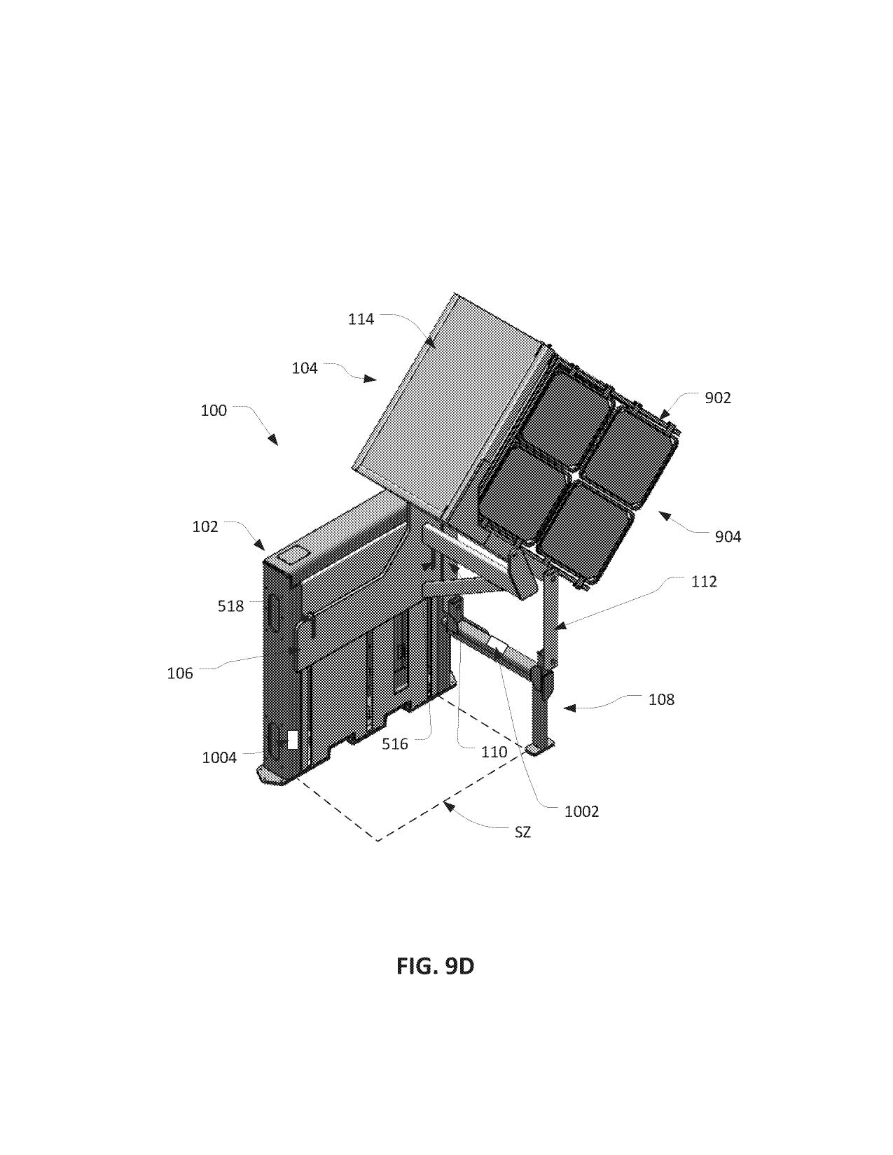

FIGS. 1-4 illustrate one example embodiment of a container unloading apparatus 100 consistent with the present disclosure. In general, the illustrated example apparatus 100 includes a mast 102, a frame 104, a drive interface 106, an outrigger 108, a first constraint arm 110, and a second constraint arm 112. The mast 102 is coupled to the frame 104 through the drive interface 106. The outrigger 108 is coupled to the mast 102 and extends forwardly from the mast 102 adjacent the frame 104. The mast 102 is configured to drive the drive interface 106 in a substantially linear vertical direction between a lowered position corresponding to a loading position of the frame 104 shown, for example, in FIGS. 1-4, and a raised position corresponding to an unloading position of the frame 104 shown, for example, in FIG. 9D. The frame 104 is rotatably coupled to the drive interface 106 and rotatably coupled to ends of the first 110 and second 112 constraint arms. Opposite ends of the first 110 and second 112 constraint arms are rotatably coupled to the outrigger 108.

When the drive interface 106 is in a lowered position the frame 104 is in the loading position, as shown in FIGS. 1-4, and a container 902 (FIGS. 9A-9D) may be loaded, e.g., rolled or placed, on a platform 114 of the frame 104. To unload the container 902, the mast 102 may be operated to drive the drive interface 106 linearly and vertically toward the raised position of the drive interface 106 shown in FIG. 9D. As the drive interface 106 moves to the raised position, the frame 104 and the container 902 supported thereby rotate relative to the drive interface 106, the first constraint arm 110, and the second constraint arm 112, and the first constraint arm 110 and the second constraint arm 112 rotate relative to the outrigger 108. This results in an upward and rotational movement of the frame 104 and the container 902. When the drive interface 106 is in the raised position, the frame 104 is in an unloading position, as shown in FIG. 9D for emptying items from an open top 904 of the container 902.

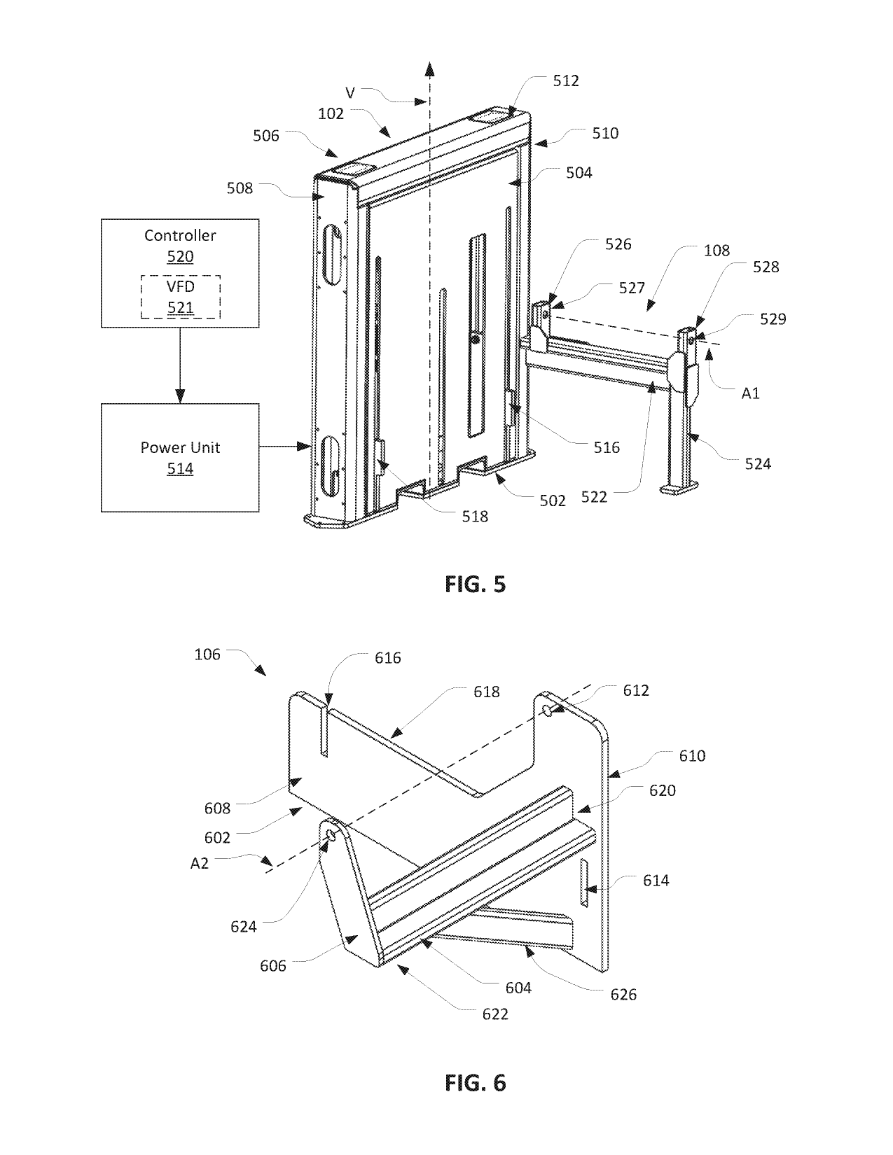

With reference also to FIG. 5, the mast 102 is a rigid structure, e.g., formed from metallic components, with a bottom 502 configured to lay flat on a floor surface. The mast 102 may be fixedly attached to a portion of the floor surface (i.e., the mast 102 may be bolted to the floor surface). In some embodiments, the mast 102 may be removably positioned on the floor surface to allow for portability of the apparatus 100. In some embodiments, the mast 102 may be mounted on a wheeled base to allow the apparatus 100 to be repositioned within a facility. The wheeled base may include locking mechanisms to fix the position of the apparatus 100 during operation. In the illustrated example embodiment, the mast 102 is generally rectangular with a front 504, a rear 506, and left 508, and right 510 sides.

The mast 102 is vertically oriented and includes a housing 512, a power unit 514, and first 516 and second 518 linearly movable members coupled to the power unit 514. In some embodiments, the power unit 514 may be disposed within the housing 512, and in other embodiments the power unit 514 may be at least partially disposed outside of the housing 512. The power unit 514 may use hydraulic, pneumatic, and/or electric power, e.g., a known hydraulic cylinder, pneumatic cylinder, linear actuator, electro-hydraulic actuator, etc. for driving the linearly movable members 516, 518 linearly in a substantially vertical direction. In FIG. 5, the arrow V, which is perpendicular to the bottom 502 of the mast 102 and to the floor surface, indicates a vertical direction. The power unit 514 drives the linearly movable members 516, 518 from a lowered position, as shown in FIG. 5, to a raised position as shown in FIG. 9D. Although the illustrated example embodiment includes first 516 and second 518 linearly movable members coupled to the power unit 514, it is to be understood that an apparatus consistent with the present disclosure may include a mast with any number of linearly movable members driven by a power unit.

A controller 520 may be coupled to the power unit 514 through a wired or wireless connection to provide control signals for energizing the power unit 514 to move the frame 104 between the loading and unloading positions. The controller 520 may provide the control signals to the power unit 514 autonomously, or in response, at least in part, to operator input.

In some embodiments, the power unit 514 may include an electric motor for driving the linearly movable members 516, 518. The electric motor may be controlled by a variable frequency drive (VFD) 521. The VFD 521 may be coupled to the controller 520, as shown in FIG. 5, to allow the speed of the frame 104 to be controlled, e.g., in response to one or more position sensors configured to sense a position of the frame 104, as the frame 104 moves between the loading position and the unloading position to provide controlled emptying of the container 902. In some embodiments, the variable frequency drive 521 may provide a safety feature by controlling movement of the frame 104 in response to outputs of one or more safety zone sensors, as described further below.

In the illustrated example embodiment, the outrigger 108 includes a horizontal member 522, an outer leg 524, a first pivot extension 526, and a second pivot extension 528. A first end of the horizontal member 522 is coupled to the mast 102 and extends from the front 504 of the mast 102 adjacent the right 510 side thereof for positioning adjacent a right side 808 (see e.g., FIG. 8) of the frame 104. In some embodiments, for example, the first end of the horizontal member 522 may extend into an opening in the mast 102 and be supported by the mast 102.

With reference also to FIG. 1, a first leg 116 of an L-shaped support plate 118 is secured to the right 510 side of the mast 102 and a second leg 120 of the support plate is secured to the horizontal member 522. The L-shaped support plate 118 stabilizes the horizontal member 522 with respect to the mast 102. The outer leg 524 extends downwardly from a second end of the horizontal member 522 to support the horizontal member 522 on a floor surface.

The first pivot extension 526 extends upwardly from the horizontal member 522 adjacent the first end of the horizontal member 522 and adjacent the mast 102. The second pivot extension 528 extends upwardly from the horizontal member 522 adjacent the second end of the horizontal member 522. The first pivot extension 526 includes a mounting feature 527, e.g., a hole therethrough, and the second pivot extension 528 includes a mounting feature 529 that is axially aligned with the mounting feature 527 in the first pivot extension 526 as illustrated by axis A1 in FIG. 5. The mounting features 527, 529 are configured for pivotally mounting the first 110 and second 112 constraint arms, respectively, to the outrigger 108, so that the first 110 and second 112 constraint arms rotate about the axis A1 (see also FIG. 1) relative to the first 526 and second 528 pivot extensions of the outrigger 108.

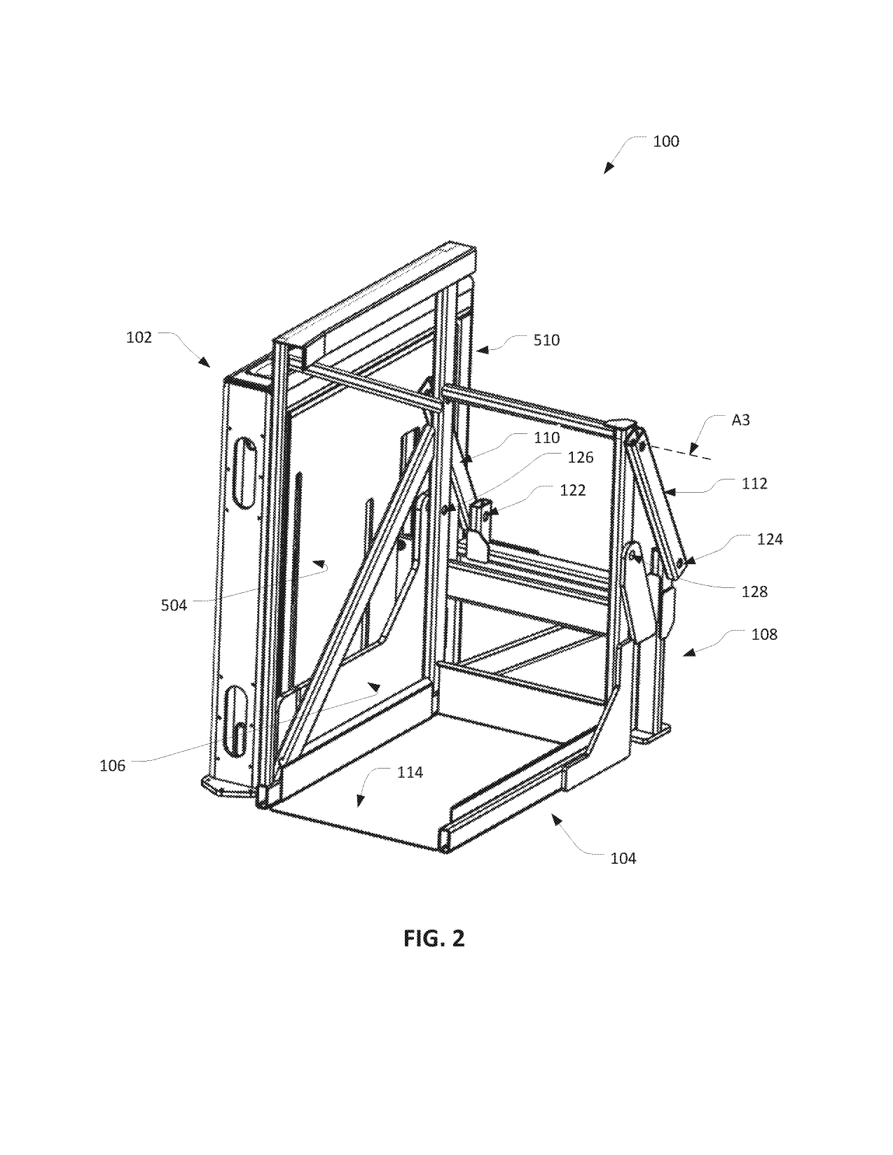

In the illustrated example embodiment, the mounting features 527, 529 are shown as holes extending through the first pivot extension 526 and the second pivot extension 528, respectively. The first 110 and second 112 constraint arms may be pivotally coupled to the first pivot extension 526 and second pivot extension 528, e.g., by respective pivot pins 122, 124 (FIG. 2) extending through corresponding holes in the first 110 and second 112 constraint arms and the holes in the first pivot extension 526 and the second pivot extension 528. It is to be understood, however, that mounting features 527, 529 may be any known features for establishing a pivotable coupling between the first 110 and second 112 constraint arms and the first 526 and second 528 pivot extensions. The mounting features 527, 529 and other mounting features described herein as providing a pivotable coupling between components may, for example, be configured as holes for receiving pivot pins to couple the components, pins on one of the components configured to be rotatably received in a corresponding hole in the other of the components, clevis plate and clevis pin combinations, etc.

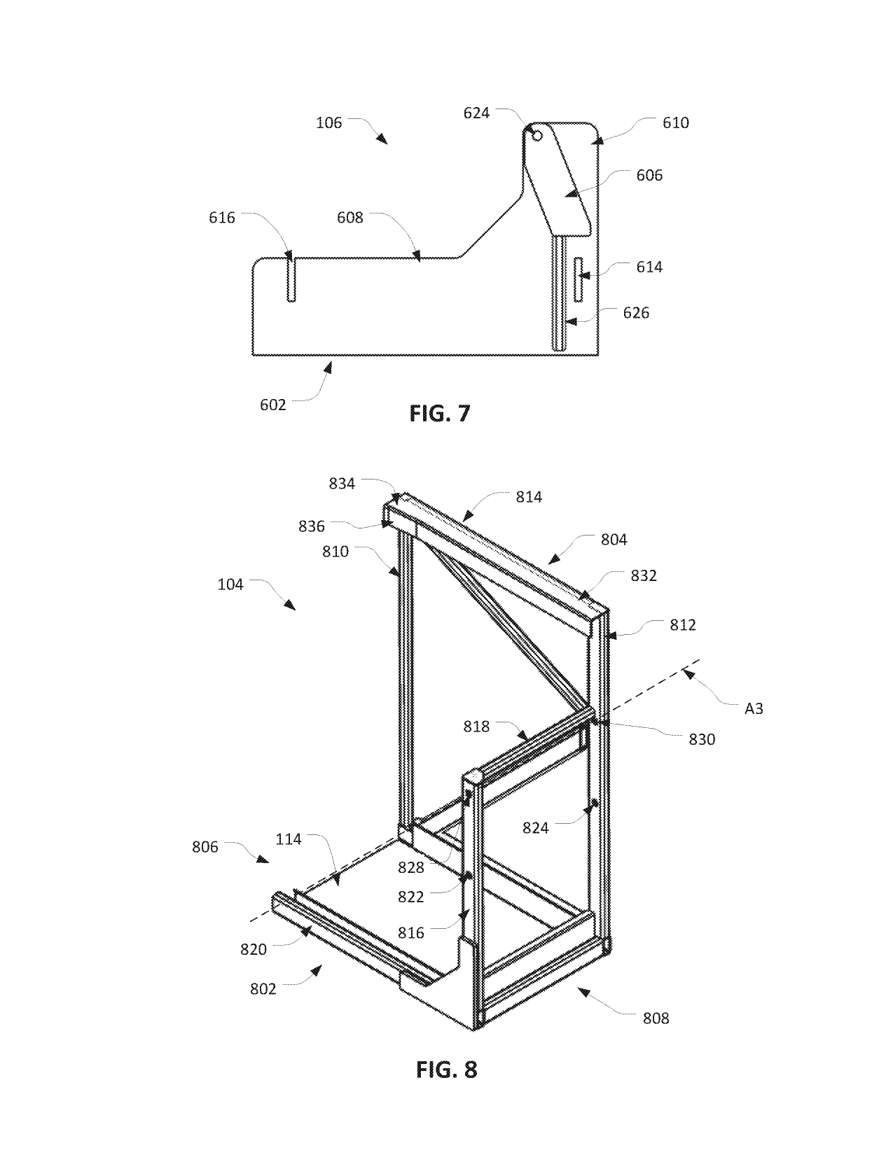

Turning to FIGS. 6 and 7, the drive interface 106 is a rigid member including a main plate 602, a horizontal extension 604, and a pivot arm 606. The main plate 602 is generally L-shaped having a first leg 608 and a second leg 610. A mounting feature 612 is provided on the second leg 610 of the main plate 602 for pivotally coupling the frame 104 to the main plate 602. A first slot 614 is provided in the main plate 602 adjacent the second leg 610 for receiving the first linearly movable member 516. The first slot 614 is bounded by surfaces of the main plate 602 and the first linearly movable member 516 may extend at least partially through the first slot 614. A second slot 616 is provided in the main plate 602 adjacent an end of the first leg 608 for receiving the second linearly movable member 518. The second slot 616 may have a top portion intersecting a top of the first leg 608 so that the top of the second slot 616 is open at the top thereof, and the second linearly movable member 518 may extend at least partially through the second slot 616.

Although the illustrated example embodiment shows the drive interface 106 having an L-shaped main plate 602, in some embodiments the main plate 602 may have other configurations. For example, the main plate 602 may be a planar plate, a U-shaped member, or any other rigid structural member suitable for coupling the frame 104 to the linearly movable members 516, 518 of the mast 102.

When the first linearly movable member 516 is disposed in the first slot 614 and the second linearly movable member 518 is disposed in the second slot 616, the drive interface 106 may be fixed to the first linearly movable member 516 and the second linearly movable member 518 with a rear 618 of the main plate 602 in opposed facing relationship to the front 504 of the mast 102. Linear movement of the first linearly movable member 516 and the second linearly movable member 518 causes corresponding linear movement of the drive interface 106. When the first linearly movable member 516 and the second linearly movable member 518 are in the lowered position, as shown in FIG. 5, the drive interface 106 is in the lowered position, and the frame 104 is in the loading position, as shown in FIG. 1. When the first linearly movable member 516 and the second linearly movable member 518 are in the raised position, as shown in FIG. 9D, the drive interface 106 is in the raised position, and the frame 104 is in the unloading position.

The horizontal extension 604 has a first end 620 extending from the front of the second leg 610 of the main plate 602 at a position above the first slot 614 to a second end 622. The pivot arm 606 extends upwardly adjacent the second end 622 of the horizontal extension 604 and is angled in a direction toward the end of the first leg 608. A distal end of the pivot arm 606 has a mounting feature 624. The mounting feature 624 in the pivot arm 606 is axially aligned with the mounting feature 612 in the main plate 602 as illustrated by axis A2 in FIG. 6. The mounting features 612, 624 are configured for pivotally mounting the frame 104 to the drive interface 106, e.g., using pivot pins 126, 128, as shown in FIG. 2 so that the frame 104 rotates about the axis A2 relative to the drive interface 106 (and the mast 102). A support arm 626 extends from the main plate 602 adjacent a bottom thereof to a bottom of the horizontal member 522 to support the horizontal member 522 with respect to the main plate 602.

As shown particularly in FIG. 8, the frame 104 is a rigid member including the platform 114 and having front 802, rear 804, left 806 and right 808 sides. A rear post 810 extends upwardly from a left, rear corner of the platform 114, a rear pivot post 812 extends upwardly from the right rear corner of the platform 114, a rear crossbar 814 extends horizontally between the top of the rear post 810 and the rear pivot post 812, a front pivot post 816 extends upwardly from the right, front corner of the platform 114, and a right side cross bar 818 extends horizontally between a top of the front pivot post 816 and the rear pivot post 812.

The left side 806 of the frame 104 is open and unobstructed by any upwardly extending walls and may include a ramp portion to facilitate rolling or sliding a container 902 onto the platform 114. In illustrated example apparatus 100 shown in FIG. 4, the outrigger 108 extends from the front of the mast 102 to be positioned adjacent the right side 808 of the frame 104, which is the side opposite from the open left side 806. The front 804 of the frame 104 has a retaining wall 820 extending upwardly from the platform 114 for retaining a container 902 on the platform 114 but allowing unobstructed access to the container 902.

Although the illustrated example embodiment shows the platform 114 configured to receive a rolling container 902, in some embodiments the platform 114 may include features such as locating pins, clamps, or other retention features for securing non-rolling containers on the platform 114. In some embodiments, the platform 114 may include a conveyor, rollers, or other features to facilitate loading and unloading of containers.

The front pivot post 816 includes a bottom mounting feature 822 configured to pivotally couple with the mounting feature 624 in the distal end of the pivot arm 606 of the drive interface 106 to pivotally couple the front pivot post 816 to the pivot arm 606. The rear pivot post 812 has a bottom mounting feature 824 that aligns with the mounting feature 612 in the main plate 602 of the drive interface 106 to pivotally couple the rear pivot post 812 to the main plate 602 and allow rotation of the frame 104 about the axis A2 (see also FIG. 1).

The front pivot post 816 has a top mounting feature 828 vertically above the bottom mounting feature 822, and the rear pivot post 812 has a top mounting feature 830 therethrough positioned vertically above the bottom mounting feature 824. The top mounting feature 828 in the front pivot post 816 is axially aligned with the top mounting feature 830 in the rear pivot post 812 as illustrated by axis A3 in FIG. 8.

With reference also to FIGS. 1-4, the first constraint arm 110 is an elongate linear member having a first end pivotally coupled, e.g., using a pivot pin 130, to the top mounting feature 830 in the rear pivot post 812 and a second end pivotally coupled to the mounting feature 527 in the first pivot extension 526. The second constraint arm 112 is an elongate linear member having a first end pivotally coupled, e.g., using a pivot pin 132, to the top mounting feature 828 in the front pivot post 816 and a second end pivotally coupled to the mounting feature 529 in the second pivot extension 528. The rear pivot post 812 is thus pivotally coupled to the first end of the first constraint arm 110, and the front pivot post 816 is pivotally coupled to the first end of the second constraint arm 112. The second end of the first constraint arm 110 is pivotally coupled to the first pivot extension 526 and the second end of the second constraint arm 112 is pivotally coupled to the second pivot extension 528. This allows rotation of the first 110 and second 112 constraint arms about the axis A1 relative to the outrigger and rotation of the frame 104 about the axis A3 relative to the first 110 and second 112 constraint arms.

With particular reference to FIGS. 1-3, when the frame 104 is in the loading position, the axis A1 about which the first 110 and second 112 constraint arms rotate relative to the first 526 and second 528 pivot extensions of the outrigger 108 is at a first height H1 above the bottom 133 of the platform 114. The axis A2 about which the frame 104 rotates relative to the drive interface 106 is at a second height H2 above the bottom 133 of the platform 114. The axis A3 about which the frame 104 rotates relative to the first 110 and second 112 constraint arms has a third height H3 above the bottom 133 of the platform 114. In the illustrated example embodiment, H1<H2<H3 when the frame 104 is in the loading position. Also, the axis A1 is spaced from the axis A2 by a fixed horizontal distance D. The distance D remains substantially constant as the frame 104 is moved from the loading position to the unloading position. Although the illustrated example embodiment positions the axes A1, A2, and A3 such that H1<H2<H3 when the frame 104 is in the loading position, the specific values of H1, H2, and H3 and the distance D between axes A1 and A2 may be selected to achieve desired motion characteristics, a desired envelope space, and a desired rotation angle for a particular application.

In the illustrated example embodiment, an optional container restraint 832 is provided on the rear crossbar 814. With reference also to FIG. 4, the container restraint 832 is configured as a rigid elongate L-shaped member having a first leg 834 coupled to a top of the rear cross bar 814 and extending forwardly over the platform 114. A second leg 836 of the L-shaped member extends downwardly from the first leg 834 toward the platform 114 to define a space 838 between the second leg 836 and the rear post 810 and the rear pivot post 812. Although an L-shaped container restraint 832 is illustrated, the container restraint 832 may be provided in a variety of configurations and locations, e.g., a sliding member coupled to the rear post 810 and the rear pivot post 812 for slidably adjusting the height of the container restraint 832, one or more downwardly extending hooks, etc. In some embodiments, the container restraint 832 may be adjustable to accommodate containers of different sizes and configurations.

As shown particularly in FIG. 9A, a container 902 may be positioned on the platform 114 by rolling or sliding the container 902 onto the platform 114 with a feature 906, e.g. the top of a rear wall, of the container 902 passing into an open end of the container restraint 832 so that at least a portion of the feature 906 is disposed in the space 838 defined by the container restraint 832. When the container 902 is lifted and rotated by the apparatus 100, the feature 906 of the container 902 may contact, or be retained by, the container restraint 832. This contact may prevent the container 902 from falling out of the frame 104 while the frame 104 moves from the loading position to the unloading position.

Although specific embodiments of the mast 102, the outrigger 108, the drive interface 106, and the frame 104 are shown and described herein, it will be recognized that each of these features may be provided in a variety of configurations. For example, the size, shape and dimensions of the of these features may be selected depending on the configuration of the container 902 to be loaded or emptied using the apparatus 100, the space where apparatus 100 is to be used, etc. Also, the relative positions of the mast 102, the outrigger 108, and/or the frame 104 may be modified from the illustrated embodiment. For example, the outrigger 108 may extend from the left side of the mast 102, and a container 902 may be rolled on the platform 114 from the right side. Although the illustrated example embodiment includes a first constraint arm 110 and a second constraint arm 112, an apparatus consistent with the present disclosure may include any number, i.e., one or more constraint arms. The illustrated example embodiment is thus provided by way of illustration, not of limitation.

FIGS. 9A-9D respectively show different positions of the frame 104 as the frame 104 transitions from the loading position shown in FIGS. 1-4 and 9A to the unloading position shown in FIG. 9D. In the loading position, as shown for example in FIG. 9A, the container 902 may be loaded, e.g., rolled, slid, placed, etc. onto the platform 114 from an open side of the container 902, i.e., the left side 806 in the illustrated embodiment. In some embodiments, the container 902 may be loaded onto the platform 114 so that the feature 906 of the container 902 is disposed in the space 838 defined by the container restraint 832. In the loading position, the first linearly movable member 516, the second linearly movable member 518, and the drive interface 106 are in their lowered positions.

In FIG. 9B, the frame 104 is in an intermediate position during transition from the loading position shown in FIG. 9A to the unloading position shown in FIG. 9D. In the position illustrated in FIG. 9B, the mast 102 has moved the drive interface 106 vertically (in the direction of arrow V in FIG. 5) from the position shown in FIG. 9A. As a result, the frame 104 has moved upwardly and has rotated to the right about the axis A2 relative to the drive interface 106 and about the axis A3 relative to the first constraint arm 110 and the second constraint arm 112. The first constraint arm 110 and the second constraint arm 112 have rotated to the right about the axis A1 relative to the outrigger. The frame 104 has thus been lifted and rotated to the right by about 45 degrees compared to the loading position of the frame 104.

In FIG. 9C, the frame 104 is in a further intermediate position during transition from the loading position shown in FIG. 9A to the unloading position shown in FIG. 9D. In the position illustrated in FIG. 9C, the mast 102 has moved the drive interface 106 further vertically from the position shown in FIG. 9B. As a result, the frame 104 has moved further upwardly and has rotated further to the right about the axis A2 and about the axis A3 compared to the position shown in FIG. 9B. The first constraint arm 110 and the second constraint arm 112 have rotated further to the right about the axis A1 compared to the position shown in FIG. 9B. The frame 104 has thus been further lifted and rotated to the right by about 80 degrees compared to the loading position of the frame 104.

In FIG. 9D, the mast 102 has moved the drive interface 106 to its raised position and the frame 104 is in the unloading position. As a result, the frame 104 has moved further upwardly and has rotated further to the right about the axis A2 and about the axis A3 compared to the position shown in FIG. 9C. The first constraint arm 110 and the second constraint arm 112 have rotated to the left about the axis A1 compared to the position shown in FIG. 9C. The frame 104 has thus been lifted and forwardly rotated by about 135 degrees compared to the loading position. In this unloading position, the open top 904 of the frame 104 is downwardly oriented to allow the contents of the container 902 to empty from the open top 904 of the container 902 and, for example, onto a receptacle (not shown) such as a platform, a conveyor or receiving container (not shown). Transition of the frame 104 from the unloading position shown in FIG. 9D back to the loading position shown in FIG. 9A may proceed in a reverse order from that described above. Although the illustrated example embodiment shows the frame 104 rotating approximately 135 degrees from the loading position to the unloading position, in some embodiments the frame 104 may rotate through a different angle depending on the configuration of the apparatus 100 and the type of container being unloaded.

FIG. 9D also illustrates a safety zone SZ established beneath the frame 104 when the frame 104 is in the unloading position. The safety zone SZ extends beneath the frame 104 from the front of the frame 104 to the mast 102 and across the width of the frame 104. In the illustrated example embodiment, the safety zone SZ is established by a first safety zone sensor 1002 positioned on the horizontal member 522 of the outrigger 108 and a second safety zone sensor 1004 positioned near the bottom of the left side 508 of the mast 102. The first safety zone sensor 1002 and the second safety zone sensor 1004 are configured to detect the presence of a person or object within the safety zone SZ and provide output signals representative thereof to the controller 520. In some embodiments, the first safety zone sensor 1002 and the second safety zone sensor 1004 may be optical sensors, e.g., laser sensors, infrared sensors, light curtains, or other known optical sensing devices suitable for detecting the presence of a person or object within the safety zone SZ.

When a person or object is detected within the safety zone SZ, the controller 520 provides a control signal to the power unit 514 to discontinue movement of the frame 104 toward the unloading position until the person or object is removed from the safety zone SZ. In some embodiments, the variable frequency drive 521 may control the speed of the power unit 514 in response to the output signals from the first safety zone sensor 1002 and the second safety zone sensor 1004, for example by slowing the movement of the frame 104 as it approaches the unloading position when a person or object is detected within the safety zone SZ, and stopping the movement of the frame 104 if the person or object remains within the safety zone SZ. In some embodiments, the safety zone SZ may dynamically adjust depending on the position of the frame 104. For example, one or more position sensors may detect when the frame 104 has reached a threshold height or rotation angle and signal the controller 520 to activate the first safety zone sensor 1002 and the second safety zone sensor 1004 to establish the safety zone SZ.

In some embodiments, the apparatus 100 may include one or more sensors for detecting the position of the frame 104, the drive interface 106, or the container 902 during operation. Such sensors may be coupled to the controller 520 to provide feedback for controlling the power unit 514. For example, position sensors may be used to detect when the frame 104 has reached the loading position or the unloading position, and the controller 520 may automatically stop the power unit 514 when the frame 104 reaches a desired position. In some embodiments where the power unit 514 includes an electro-hydraulic actuator, position sensing capability may be integral with the electro-hydraulic actuator for detecting the position of the frame 104 during operation and providing position feedback to the controller 520.

In some embodiments, the apparatus 100 may include one or more safety features such as emergency stop mechanisms, load sensors, or guarding to protect operators and nearby personnel during operation. Such safety features may be coupled to the controller 520 to automatically stop operation of the apparatus 100 if an unsafe condition is detected. In some embodiments, the variable frequency drive 521 may provide a safety feature by controlling movement of the frame 104 in response to outputs of one or more safety sensors, for example by slowing or stopping movement of the frame 104 when an unsafe condition is detected.

In some embodiments, the apparatus 100 may be configured to interface with automated material handling systems such as conveyors, robotic systems, or automated guided vehicles. In such embodiments, the controller 520 may receive control signals from a facility control system to coordinate operation of the apparatus 100 with other material handling equipment.

Advantageously, due to the vertical and rotational movement of the frame 104 as the frame 104 moves from the loading position to the unloading position the frame 104 remains in a compact envelope space. The envelope space may be selectively modified in embodiments consistent with the present disclosure by modifying the position of axes A1, A2, and/or A3, e.g. by modifying the height H1, H2 and/or H3, and/or the distance D. The specific envelope space in any embodiment consistent with the present invention also depends on the size of the apparatus 100, e.g. the size of the mast 102 and the frame 104.

Consistent with one aspect of the present disclosure there is provided an apparatus for emptying the contents of a container including a drive interface; a frame pivotally coupled to the drive interface and including a platform for supporting a container; a mast coupled to the drive interface and including a power unit for driving the drive interface vertically to move the frame from a loading position for loading the container on the platform to an unloading position for emptying contents from the container; an outrigger coupled to the mast and extending from the mast and adjacent a side of the frame; and at least one constraint arm pivotally coupled to the outrigger and pivotally coupled to the frame, whereby as the frame moves from the loading position to the unloading position the frame moves upwardly and rotates relative to the drive interface and the at least one constraint arm, and the at least one constraint arm rotates relative to the outrigger.

In some embodiments, the mast includes at least one linearly movable member coupled to the drive interface and the power unit is configured for driving the linearly movable member in a vertical direction. In some embodiments, the drive interface includes a main plate including at least one slot for receiving the at least one linearly movable member.

In some embodiments, the drive interface includes a first mounting feature and a second mounting feature axially aligned with the first mounting feature, and the frame is pivotally coupled to the first mounting feature and the second mounting feature. In some embodiments, the drive interface includes a main plate, a horizontal extension extending forwardly from a front surface of the main plate, and a pivot arm extending upwardly adjacent an end of the horizontal extension, and the first mounting feature is on the main plate and the second mounting feature is on the pivot arm.

In some embodiments, the frame includes a rear pivot post extending upwardly relative to the platform and a front pivot post extending upwardly from the platform, and the rear pivot post and the front pivot post are pivotally coupled to the drive interface. In some embodiments, the at least one constraint arm includes a first constraint arm and a second constraint arm, and the first constraint arm is pivotally coupled to the rear pivot post and to the outrigger, and the second constraint arm is pivotally coupled to the front pivot post and the outrigger. In some embodiments, the outrigger includes a first pivot extension extending upwardly therefrom and a second pivot extension extending upwardly therefrom, and the first constraint arm is pivotally coupled to the first pivot extension and the second constraint arm is pivotally coupled to the second pivot extension.

In some embodiments, the at least one constraint arm is configured to rotate about a first axis relative to the outrigger, the frame is configured to rotate about a second axis relative to the drive interface, and the frame is configured to rotate about a third axis relative to the at least one constraint arm, the first axis being positioned at a first height H1 from a bottom of the platform when the frame is in the loading position, the second axis being positioned at a second height H2 from the bottom of the platform when the frame is in the loading position, and the third axis being positioned at a third height H3 from the bottom of the platform when the frame is in the loading position, wherein H1<H2<H3. In some embodiments, the first axis is spaced from the second axis by a fixed horizontal distance as the frame moves from the loading position to the unloading position.

In some embodiments, the frame includes a container restraint for retaining the container on the frame as the frame moves from the loading position to the unloading position. In some embodiments, the frame includes a rear post extending upwardly from the platform, a rear pivot post extending upwardly from the platform, and a rear crossbar extending between the rear post and the rear pivot post, and the container restraint is coupled to the rear crossbar. In some embodiments, the container restraint includes an elongate L-shaped member defining a space for receiving a feature of the container.

In some embodiments, the apparatus further includes a controller coupled to the power unit and at least one safety zone sensor configured to detect a presence of a person or object within a safety zone established beneath the frame when the frame is in the unloading position and provide output signals to the controller. In some embodiments, the controller is configured to discontinue movement of the frame toward the unloading position when a person or object is detected within the safety zone. In some embodiments, the at least one safety zone sensor includes a first safety zone sensor positioned on the outrigger and a second safety zone sensor positioned on the mast.

In some embodiments, the power unit includes an electric motor and a variable frequency drive configured to control a speed of the drive interface as the frame moves between the loading position and the unloading position. In some embodiments, the variable frequency drive is configured to control movement of the frame in response to output signals from one or more safety zone sensors.

According to another aspect of the present disclosure there is provided an apparatus for emptying the contents of a container including a drive interface including a first mounting feature and a second mounting feature axially aligned with the first mounting feature; a frame pivotally coupled to the first mounting feature and the second mounting feature and including a platform for supporting a container, the frame having an open side for receiving the container on the platform; a mast including at least one linearly movable member coupled to the drive interface and including a power unit for driving the at least one linearly movable member vertically to move the frame from a loading position for loading the container on the platform to an unloading position for emptying contents from the container; an outrigger coupled to the mast and extending from the mast and adjacent a side of the frame opposite from the open side; a first constraint arm pivotally coupled to the outrigger and pivotally coupled to the frame; and a second constraint arm pivotally coupled to the outrigger and pivotally coupled to the frame; whereby as the frame moves from the loading position to the unloading position, the first and second constraint arms are configured to rotate about a first axis relative to the outrigger, the frame is configured to rotate about a second axis relative to the drive interface, and the frame is configured to rotate about a third axis relative to the first and second constraint arms, the first axis being positioned at a first height H1 from a bottom of the platform when the frame is in the loading position, the second axis being positioned at a second height H2 from the bottom of the platform when the frame is in the loading position, and the third axis being positioned at a third height H3 from the bottom of the platform when the frame is in the loading position, wherein H1<H2<H3.

According to another aspect of the present disclosure there is provided a method of emptying contents from a container using an apparatus including a mast, a drive interface coupled to the mast, a frame pivotally coupled to the drive interface and including a platform, an outrigger coupled to the mast, and at least one constraint arm pivotally coupled to the outrigger and pivotally coupled to the frame. The method includes placing a container on the platform of the frame when the frame is in a loading position; and operating a power unit of the mast to drive the drive interface vertically to cause the frame to move from the loading position to an unloading position, wherein driving the drive interface vertically causes rotation of the frame relative to the drive interface and causes rotation of the at least one constraint arm relative to the outrigger, such that the frame moves upwardly and rotates from the loading position to the unloading position.

As used herein, the term 'vertically' means in a substantially linear direction within 10 degrees of parallel to the direction of gravity. As used herein, the term 'substantially' when used in the context of a direction, orientation, or spatial relationship means within 10 degrees of the stated direction, orientation, or relationship. When used in other contexts, the term 'substantially' means within a range that does not materially affect the structure or function of the described element or assembly as would be understood by one of ordinary skill in the art. The term “coupled" as used herein refers to any connection, coupling, link, or the like by which signals carried by one system element are imparted to the "coupled" element. Such “coupled" devices, or signals and devices, are not necessarily directly connected to one another and may be separated by intermediate components or devices that may manipulate or modify such signals. Likewise, the terms “connected” or “coupled” as used herein in regard to mechanical or physical connections or couplings is a relative term and does not require a direct physical connection. Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Throughout the entirety of the present disclosure, use of the articles "a" and/or "an" and/or "the" to modify a noun may be understood to be used for convenience and to include one, or more than one, of the modified noun, unless otherwise specifically stated. The terms "comprising", "including" and "having" are intended to be inclusive and mean that there may be additional elements other than the listed elements. The phrase “at least one of A and B” should be understood to mean “only A, only B, or both A and B.”

Spatially relative terms, such as “beneath,” below,” upper,” “lower,” “above”, “left”, “right” and the like may be used herein for ease of description to describe one element or feature’s relationship to another element(s) or feature(s) as illustrated in the drawings. These spatially relative terms are intended to encompass different orientations of the device in use or operation in addition to the orientation shown in the drawings. For example, if the device in the drawings is turned over, elements described as “below” or “beneath” other elements or features would then be oriented “above” the other elements or features. Thus, the exemplary term “below” may encompass both an orientation of above and below. The device may be otherwise oriented (rotated 90 degrees or at other orientations) and the spatially relative descriptors used herein interpreted accordingly.

Although the terms “first,” “second,” “third” etc. may be used to describe various elements, components, regions, layers and/or sections, these elements, components, regions, layers and/or sections are not to be limited by these terms as they are used only to distinguish one element, component, region, layer or section from another element, component, region, layer or section. Thus, a first element, component, region, layer, or section could be termed a second element, component, region, layer, or section without departing from the scope and teachings of the present invention.

As used herein, use of the term “nominal” or “nominally” when referring to an amount means a designated or theoretical amount that may vary from the actual amount.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. An apparatus for emptying the contents of a container comprising:
a drive interface;
a frame pivotally coupled to the drive interface and comprising a platform for supporting a container;
a mast coupled to the drive interface and comprising a power unit for driving the drive interface vertically to move the frame from a loading position for loading the container on the platform to an unloading position for emptying contents from the container;
an outrigger coupled to the mast and extending from the mast and adjacent a side of the frame; and
at least one constraint arm pivotally coupled to the outrigger and pivotally coupled to the frame,
whereby as the frame moves from the loading position to the unloading position the frame moves upwardly and rotates relative to the drive interface and the at least one constraint arm, and the at least one constraint arm rotates relative to the outrigger.

2. The apparatus of claim 1, wherein the mast comprises at least one linearly movable member coupled to the drive interface and the power unit is configured for driving the linearly movable member in a vertical direction.

3. The apparatus of claim 2, wherein the drive interface comprises a main plate comprising at least one slot for receiving the at least one linearly movable member.

4. The apparatus of claim 1, wherein the drive interface comprises a first mounting feature and a second mounting feature axially aligned with the first mounting feature, and wherein the frame is pivotally coupled to the first mounting feature and the second mounting feature.

5. The apparatus of claim 4, wherein the drive interface comprises a main plate, a horizontal extension extending forwardly from a front surface of the main plate, and a pivot arm extending upwardly adjacent an end of the horizontal extension, and wherein the first mounting feature is on the main plate and the second mounting feature is on the pivot arm.

6. The apparatus of claim 1, wherein the frame comprises a rear pivot post extending upwardly relative to the platform and a front pivot post extending upwardly from the platform, and wherein the rear pivot post and the front pivot post are pivotally coupled to the drive interface.

7. The apparatus of claim 6, wherein the at least one constraint arm comprises a first constraint arm and a second constraint arm, and wherein the first constraint arm is pivotally coupled to the rear pivot post and to the outrigger, and the second constraint arm is pivotally coupled to the front pivot post and the outrigger.

8. The apparatus of claim 7, wherein the outrigger comprises a first pivot extension extending upwardly therefrom and a second pivot extension extending upwardly therefrom, and wherein the first constraint arm is pivotally coupled to the first pivot extension and the second constraint arm is pivotally coupled to the second pivot extension.

9. The apparatus of claim 1, wherein the at least one constraint arm is configured to rotate about a first axis relative to the outrigger, the frame is configured to rotate about a second axis relative to the drive interface, and the frame is configured to rotate about a third axis relative to the at least one constraint arm, the first axis being positioned at a first height H1 from a bottom of the platform when the frame is in the loading position, the second axis being positioned at a second height H2 from the bottom of the platform when the frame is in the loading position, and the third axis being positioned at a third height H3 from the bottom of the platform when the frame is in the loading position, wherein H1<H2<H3.

10. The apparatus of claim 9, wherein the first axis is spaced from the second axis by a fixed horizontal distance as the frame moves from the loading position to the unloading position.

11. The apparatus of claim 1, wherein the frame comprises a container restraint for retaining the container on the frame as the frame moves from the loading position to the unloading position.

12. The apparatus of claim 11, wherein the frame comprises a rear post extending upwardly from the platform, a rear pivot post extending upwardly from the platform, and a rear crossbar extending between the rear post and the rear pivot post, and wherein the container restraint is coupled to the rear crossbar.

13. The apparatus of claim 12, wherein the container restraint comprises an elongate L-shaped member defining a space for receiving a feature of the container.

14. The apparatus of claim 1, further comprising a controller coupled to the power unit and at least one safety zone sensor configured to detect a presence of a person or object within a safety zone established beneath the frame when the frame is in the unloading position and provide output signals to the controller.

15. The apparatus of claim 14, wherein the controller is configured to discontinue movement of the frame toward the unloading position when a person or object is detected within the safety zone.

16. The apparatus of claim 14, wherein the at least one safety zone sensor comprises a first safety zone sensor positioned on the outrigger and a second safety zone sensor positioned on the mast.

17. The apparatus of claim 1, wherein the power unit comprises an electric motor and a variable frequency drive configured to control a speed of the drive interface as the frame moves between the loading position and the unloading position.

18. The apparatus of claim 17, wherein the variable frequency drive is configured to control movement of the frame in response to output signals from one or more safety zone sensors.

19. An apparatus for emptying the contents of a container comprising:
a drive interface comprising a first mounting feature and a second mounting feature axially aligned with the first mounting feature;
a frame pivotally coupled to the first mounting feature and the second mounting feature and comprising a platform for supporting a container, the frame having an open side for receiving the container on the platform;
a mast comprising at least one linearly movable member coupled to the drive interface and comprising a power unit for driving the at least one linearly movable member vertically to move the frame from a loading position for loading the container on the platform to an unloading position for emptying contents from the container;
an outrigger coupled to the mast and extending from the mast and adjacent a side of the frame opposite from the open side;
a first constraint arm pivotally coupled to the outrigger and pivotally coupled to the frame; and
a second constraint arm pivotally coupled to the outrigger and pivotally coupled to the frame;
whereby as the frame moves from the loading position to the unloading position, the first and second constraint arms are configured to rotate about a first axis relative to the outrigger, the frame is configured to rotate about a second axis relative to the drive interface, and the frame is configured to rotate about a third axis relative to the first and second constraint arms, the first axis being positioned at a first height H1 from a bottom of the platform when the frame is in the loading position, the second axis being positioned at a second height H2 from the bottom of the platform when the frame is in the loading position, and the third axis being positioned at a third height H3 from the bottom of the platform when the frame is in the loading position, wherein H1<H2<H3.

20. A method of emptying contents from a container using an apparatus comprising a mast, a drive interface coupled to the mast, a frame pivotally coupled to the drive interface and comprising a platform, an outrigger coupled to the mast, and at least one constraint arm pivotally coupled to the outrigger and pivotally coupled to the frame, the method comprising:
placing a container on the platform of the frame when the frame is in a loading position; and
operating a power unit of the mast to drive the drive interface vertically to cause the frame to move from the loading position to an unloading position, wherein driving the drive interface vertically causes rotation of the frame relative to the drive interface and causes rotation of the at least one constraint arm relative to the outrigger, such that the frame moves upwardly and rotates from the loading position to the unloading position.
